(19) United States
(12) Patent Application Publication
(10) Pub. No.: US 2016/0178414 A1
(43) Pub. Date: Jun. 23, 2016

(54) SYSTEM AND METHODS FOR ADDRESSING DATA QUALITY ISSUES IN INDUSTRIAL DATA

(71) Applicant: General Electric Company, Schenectady, NY (US)

(72) Inventors: Angshuman Saha, Kolkata (IN); Sridhar Dasaratha, Bangalore (IN); Nitika Bhaskar, Bangalore (IN); Janna Lindenberg, Hamburg (DE); Richard Vagliani, Aberdeen (GB)

(21) Appl. No.: 14/574,234

(22) Filed: Dec. 17, 2014

(51) Int. Cl. G01D 18/00; G01M 99/00

(52) U.S. Cl. CPC G01D 18/00; G01M 99/008

(57) ABSTRACT

Embodiments allow data cleaning of industrial data gathered from at least one sensor. The data cleaning utilizes a workflow that defines at least one cleaning step to be performed. Each cleaning step comprises detecting defects based on at least one constraint such as various models and/or statistics. Potential defects are presented to a user for feedback. The data is cleaned based on the feedback. Multiple copies of the data are stored to track all the various cleaning choices. All choices can be rolled back at will so that cleaning decisions made can be eliminated and different choices applied. Intermediate data is captured to allow reporting and auditing of the cleaning process.

### TECHNICAL FIELD

Embodiments pertain to processing industrial data. More specifically, embodiments assess and help correct data defects in industrial data received from sensors measuring real world parameters.

### BACKGROUND

As small, inexpensive sensors have become ubiquitous in recent years, there has been a veritable explosion in the amount of data being generated and collected from industrial equipment, processes, manufacturing plants, environmental sensors, and other such sources. These represent examples of industrial data where such sensors measure real world parameters. Often data measured and collected by such sensors has defects of a variety of types. Detecting and/or correcting such defects can be difficult and complicated.

### BRIEF DESCRIPTION OF THE DRAWINGS

FIG. 1 illustrates an example architecture for capturing and cleaning industrial data.

FIG. 2 illustrates an example of a flow diagram to clean data.

FIG. 3 illustrates an example of a flow diagram to detect defects.

FIG. 4 illustrates an example of a flow diagram for visualization of the data and for user feedback on detected defects.

FIG. 5 illustrates an example data visualization showing missing data.

FIG. 6 illustrates an example data visualization identifying data defects.

FIG. 7 represents an example data visualization for clock correction.

FIG. 8 represents an example flow diagram for data defect detection and cleaning.

FIG. 9 illustrates a block diagram of an example system, according to some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Various modifications to the embodiments will be readily apparent to those skilled in the art, and the generic principles defined herein may be applied to other embodiments and applications without departing from the scope of the invention. Moreover, in the following description, numerous details are set forth for the purpose of explanation. However, one of ordinary skill in the art will realize that embodiments disclosed herein may be practiced without the use of these specific details. In other instances, well-known structures and processes are not shown in block diagram form in order not to obscure the description of the embodiments disclosed herein with unnecessary detail. Thus, the present disclosure is not intended to be limited to the embodiments shown, but is to be accorded the widest scope consistent with the principles and features disclosed herein.

Embodiments disclosed herein relate to automated or semi-automated solutions for workflows to detect and correct data quality issues in datasets. The disclosure includes a comprehensive framework for addressing data quality issues in datasets arising from primarily industrial/engineering domains. The term “industrial data” includes time series data, which is data that is collected at a particular time and generally includes a time stamp or other indicator of when it was collected. Industrial data measures real world parameters associated with industrial processes, manufacturing systems, scientific measurements, and so forth.

Industrial data often includes data collected from sensors and/or other sources in a manner that results in correlations between sensor data. For example, a series of wind turbines producing electricity may include sensors with a spatial relationship between them such as elevation and/or other distance measures. Measurements of wind speed, temperature, humidity, or other such parameters from spatially related sensors will be correlated in some fashion, particularly over small distances, elevation changes, and so forth. Thus, embodiments disclosed herein can utilize such correlation to identify and/or correct defects in such data. Statistical models, physical models, physics models, correlation models, and so forth can help identify data that is “impossible” or has some other defect associated with it.

The detection and correction of the “defects” in this type of data often involves methods which are more complex than simple if-then rules or missing value flagging rules. These methods use domain-specific specialized algorithms to detect and correct data. As used herein domain is intended in its plain and ordinary meaning sense, namely a specified sphere of activity or knowledge. Furthermore, defects may include not only particular data points, but also data for a particular time segment. In addition, defects may include data from a single sensor, multiple sensors, and/or so forth. Combinations thereof are also possible. For example, a detection algorithm may identify data from time t1 to time t2 to be defective for sensors 1, 5, 6 and 9.

Often the cleaning process is a workflow of sequential steps where cleaned data from one step is fed and input to the next step. Often a user reviews results from individual steps, using various visualization mechanisms such as numeric, textual and graphical summaries, and provide feedback. The actual cleaning task often depends of the feedback. In most cases, the final cleaned version of the data is not the only end goal. Along with the cleaned data, systems also produce reports including information such as: 1) what the defects detected were; 2) why they were detected; 3) what user feedback was given; 4) what has changed in the data, and so forth. Thus systems and methods include comprehensive capabilities for reporting, generating various kinds of summaries, saving multiple copies of the data with various cleaning steps applied, and so forth. The disclosed framework takes into account these needs in a holistic fashion and includes a logical architecture to address these needs.

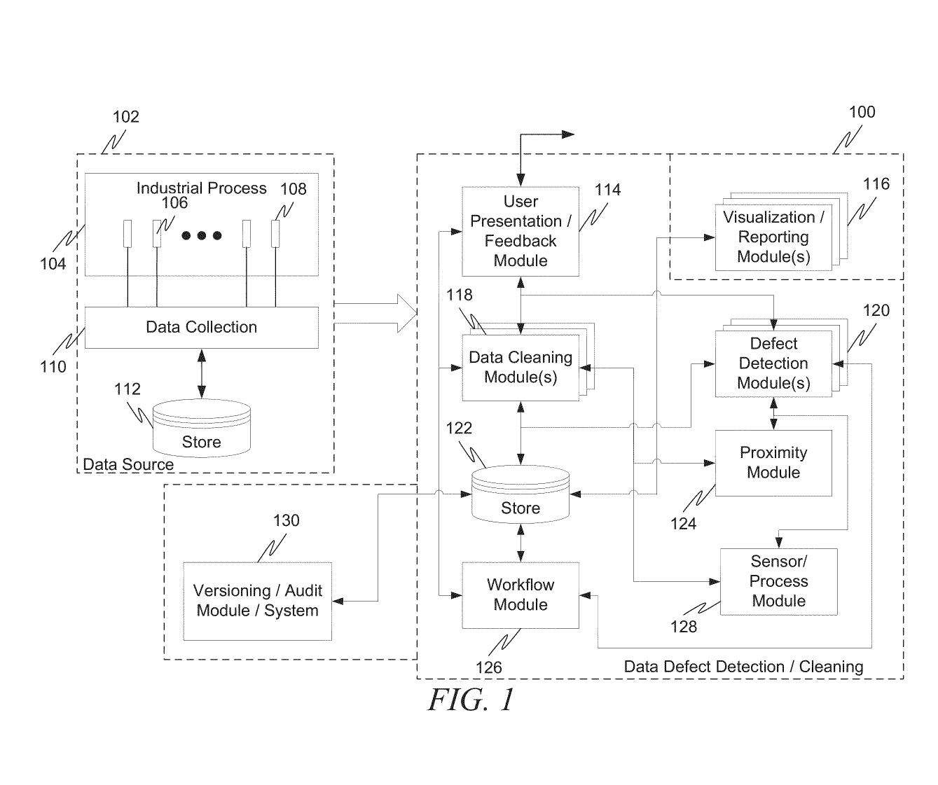

FIG. 1 illustrates an example architecture for capturing and cleaning industrial data. This architecture is described in terms of modules, which are defined and described below. As noted above, industrial data often, but not always, is time series data, which is data that is collected at a particular time and generally includes a time stamp or other indicator of when it was collected. Industrial data measures real world parameters associated with industrial processes, manufacturing systems, scientific measurements, and so forth. The representative architecture of FIG. 1 illustrates data source 102 as including an industrial process 104 or other environment in which the data is collected. In the representative architecture, data is measured by a plurality of sensors 106, 108, collected by a data collector 110, and stored in data store 112. Industrial processes, manufacturing systems, scientific measurements, and so forth often generate a lot of data and many techniques are available for ensuring that data collection and storage is performed. For the purpose of this disclosure, the manner of data collection is not important, other than to note that the data source 102 influences the models and so forth used in data defect detection and cleaning as described below.

A data defect detection and cleaning system 100 accepts data from any data source in any number of data formats. For example, in some embodiments, data can come from a single source such as a single flat file or single table from a database or from a complex source such as multiple tables from multiple databases, disparate data sources like structured and unstructured text files, database tables, and so forth. Data source 102 is simply illustrative of an example embodiment of a data source.

Data defect detection and cleaning system 100 implements a workflow for detecting and correcting data quality issues (e.g., data defects). Thus, data defect detection and cleaning system 100 comprises workflow module 126. Workflow module 126 implements the workflow that comprises a series of operations. For ease of reference and to avoid confusion with things that are performed within each workflow operation, a workflow operation will be referred to as a “step.” This does not mean, however, that workflow steps are to be interpreted according to step plus function rules. The term simply refers to a group of operations that are performed together in a workflow. Each workflow step comprises one or more of the following operations:
Data reformatting, transformation, or reorganization in preparation for the succeeding operations.
Detection of specific types of defects based on particular methods, models, and so forth.
Presenting the detected defects to a user through visualization mechanisms such as numeric, textual, graphical, or other means.
Requesting and receiving input/feedback from the user to direct whether the identified defects are actually defects, how data is cleaned, and so forth.
Cleaning the data based on specific methods that can take the user feedback as input to the method. As an example, defects that are accepted (e.g., identified by the user as defects) are cleaned while defects that are rejected (e.g., identified by the user as not defects) are left alone.
Generation of various intermediate results such as:
   Defect summaries (e.g., number of defects by variable, by type, by time segment, and so forth);
   Multiple versions of the data (e.g., cleaned data after the particular operation, uncleaned data, and so forth);
   Information about user feedback (e.g., a log of which defects were rejected by the user, accepted by the user, and so forth);
   Log of user actions; and/or
   Information that allows any or all changes to be rolled back.
Storing of the intermediate results (on specified locations in some embodiments) for later review and assessment.

Workflow module 126 coordinates other modules to ensure the proper operations are performed as specified in the workflow. Some embodiments allow the user to modify the identified workflow while other embodiments do not.

Although not specifically illustrated in FIG. 1, some embodiments of data defect detection and cleaning system 100 include a module to format, transform, reorganize, or otherwise manipulate the data prior to the other operations in the workflow step. In other embodiments, any formatting, transformation, and so forth is completed by the defect detection module 120 or a different module.

Defect detection module(s) 120 implement particular methods to detect particular types of defects in the data. Specific defects are detected through specific methods. Some methods rely on physical, statistical, or other properties and/or models to identify defects. As previously noted, industrial data often have correlations and/or variations due to various factors. Two broad categories include correlation between sensors and/or parameters and variation changes (either increased or decreased) due to various factors. Defect detection methods can utilize physical, statistical, or other properties and/or models to utilize these characteristics to detect defects. The examples below are simply representative in nature.

In one representative example, statistical models are used to detect varying correlation structure across different series of correlated data. For example, wind direction and wind speed might have a certain correlation behavior (e.g., the “normal” correlation behavior). But those series might exhibit the changed behavior in certain parts of the data. One of the algorithms used to identify such defects utilizes a Bayesian approach to model the expected patterns in data and then to identify unexpected behavior.

Another representative example detects reduced variation in sensors data due to various reasons (like atmospheric conditions). For example, the variation in wind speed with time might appear to be significantly lower compared to other comparable data sets if the atmospheric conditions affect sensor functionality. An example method to detect such defects identifies the normal range of values and the corresponding variation for each type of sensor data. The method then defines reduced variation and expected length for such events by sensor data type and maps the data sets to this category based on their match with respect to the above definitions.

Statistical models, physical models, physics models, correlation models, and so forth can help identify data that is “impossible” or has some other defect associated with it. In some embodiments, these models identify constraints to identify incorrect data. Taking the example of wind turbines that measure wind speed at various elevations, consider the wind speed data measured by two sensors located a fixed distance apart. When the difference between the wind speeds measured by the two sensors exceeds what is likely and/or possible, then a defect in the data is identified. A third sensor located in proximity to the others can help sort out which of the measured speeds contains the defect. Similarly, prior measured data may indicate when data is incorrect. As yet another example, a sensor may be calibrated to measure a minimum or maximum value and when the data from that sensor exceeds the minimum or maximum value, errors may be detected. Other models may correlate data from different types of sensors such as temperature, pressure, speed, and so forth. Thus, when one parameter changes, an appropriate model predicts that one or more other parameters are expected to change in a defined way. Sometimes physics describes relationships between different types of sensors, such as the temperature and pressure of a gas in a closed container. Sometimes models may be based on empirical information gathered over time or through experimentation.

In general, statistical models, physical models, physics models, correlation models, and so forth can help identify constraints which help identify defects. Sensor/process module 128 of FIG. 1 illustrates these model(s) that model sensors, environment, statistics, physical attributes, physics, correlation, and so forth. More particularly, in some embodiments, sensor/process module 128 provides appropriate model(s) used by defect detection module(s) 120. The models may be quite complex and often go beyond simple if-then type relationships.

The models may be of characteristics of the data (such as statistics of the data), of the sensor (such as sensor response to input, noise models, and so forth), the sensor context (such as the industrial process, environment, and so forth within which the sensor resides), and so forth. The models may account for or utilize particular sensor metadata, which is also referred to as proximity information or proximity data. Thus, measured data may include (or be related to) proximity information that details information about the sensor, the environment of the sensor, its relationship to other sensors, combinations thereof, and so forth to produce sensor metadata that is utilized in these models to identify constraints or other information used to detect defects. Examples of proximity data include, but are not limited to, the following.
Type: The type of physical variable measured by the sensor such as temperature, pressure, speed, concentration, and so forth.
Subtype: Within a given type, there can be subtypes of variables that describe characteristics of the type. As an example, the variable measured may be temperature, and the subtype may be oil inlet temperature, water coolant temperature, ambient temperature, and so forth.
Location: This includes the physical or relative location such as which machine, which part of a machine, the portion of the process, a geographic location, and so forth.
Spatial Arrangement: This describes the relationship between a sensor and related or neighboring sensors. It helps identify correlations between measured data and aids in detection of incorrect data. For example, a data defect may be detected if a big jump in temperature occurs for the oil inlet temperature sensor over a short period of time. However, the big jump may only be an error if a similar jump does not show up on sensors that are “close” or “correlated” to the oil inlet temperature sensor such as one or more oil temperature sensors located upstream and/or downstream from the oil inlet temperature.
Other sensor or environment metadata.

The term “sensor ID metadata” will be used to encompass any combination of the type and subtype portion of the proximity data. The term “sensor environment metadata” will be used to encompass any combination of the remainder of the proximity data (excluding the sensor ID metadata).

Proximity module 124 illustrated in FIG. 1 depicts retrieving and/or providing appropriate proximity data to the defect detection module 120 and/or sensor/process module 128, in the case of defect detection.

Once defects (or potential defects) are identified, some embodiments seek feedback from a user in order to guide the cleaning process. Thus, data defect detection and cleaning system 100 may comprise visualization/reporting module 116 and/or user presentation/feedback module 114. In the illustrated embodiment, these modules present appropriate data visualizations to the user and allow the user to provide feedback on suspected defects and/or otherwise direct the cleaning process. Although the embodiment of FIG. 1 illustrates these modules as separate, the functionality can be combined in various embodiments in various ways.

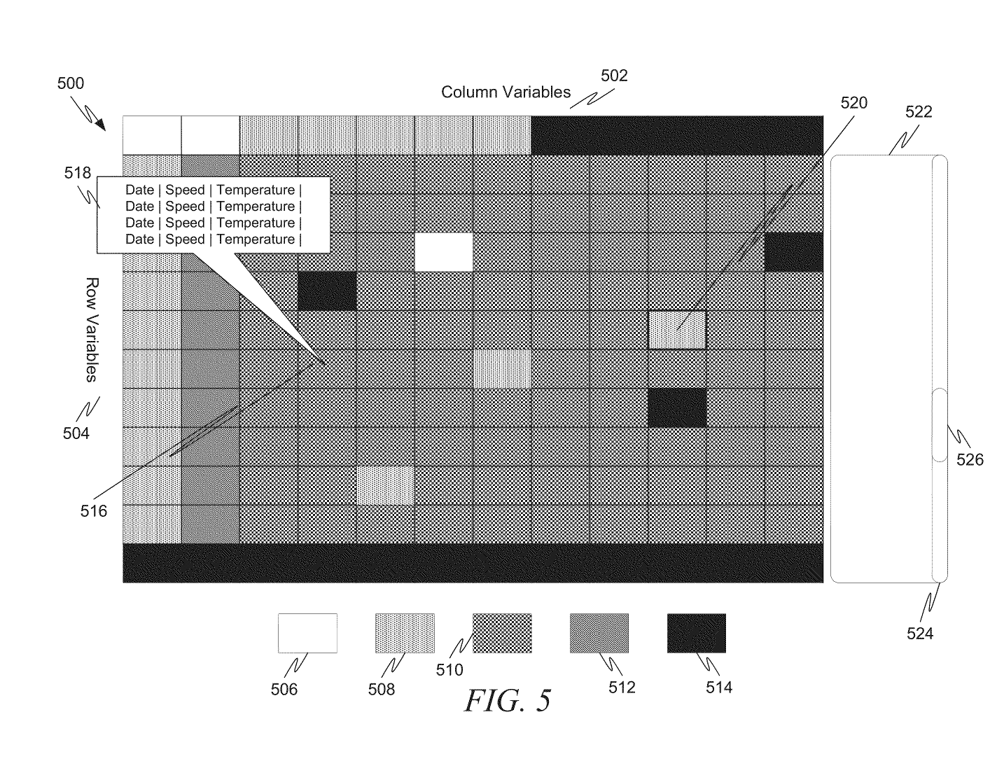

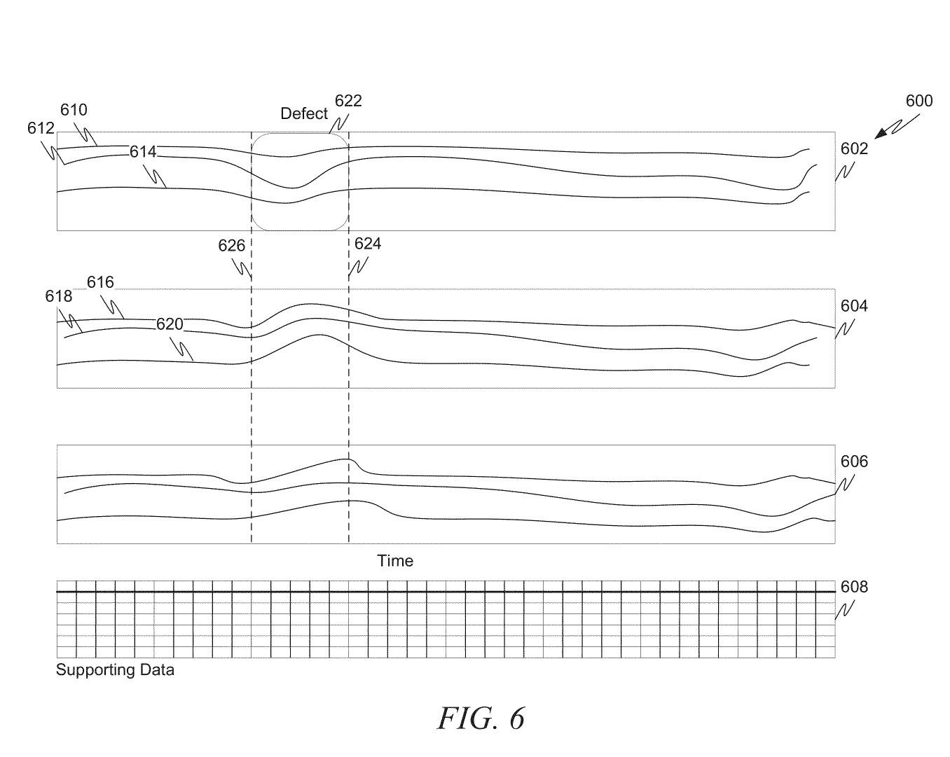

In the illustrated embodiment, visualization/reporting module 116 creates appropriate information to be presented to the user in order to identify defects or otherwise inform the user of the status of the data defect detection and cleaning operation(s). The output of this module can be numeric, textual, graphical, combinations thereof, or other mechanisms for conveying the desired information. Examples of some data visualizations are illustrated in FIGS. 5-6 below. However, other reports and/or visualizations can also be used. The dashed line surrounding the visualization/reporting module(s) 116 illustrates that these modules may be part of the data defect detection and cleaning system 100 in some embodiments or may be separate modules and/or systems that are utilized by the data defect detection and cleaning system in other embodiments.

User presentation/feedback module 114 presents the data visualizations to the user and solicits feedback. In some embodiments, this is an interactive process where the user can scroll through various suspected defects and indicate which defects should be corrected and which should be ignored. Often this interactivity is presented through a graphical user interface (GUI) or other such mechanism(s). In other embodiments, the user can provide other feedback that will be used in the cleaning process such as direction in how the defects should be corrected or cleaned. In still other embodiments, combinations thereof are utilized. Additionally, or alternatively, user feedback can be solicited in other ways than an interactive GUI, such as, for example, using batch information. Embodiments of the user presentation/feedback module 114 can store the feedback in a data store 122 or can save the feedback in some other way so that it can be consumed by a data cleaning module (e.g., the data cleaning module 118).

The data cleaning module(s) 118 take the feedback given (if any) and clean the data according to various methods. The methods are based on the type of defect being addressed and may also be based on the statistical models, physical models, physics models, correlation models, and so forth previously mentioned. Thus, the data cleaning module(s) 118 are shown connected to proximity module 124 and sensor/process module 128. These modules have been discussed previously.

Returning to examples discussed above, suppose the data defect detection module 120 identified a possible error in the wind speed measured by one sensor out of a plurality of sensors in a wind farm. The suspected defect is confirmed by the user by the user presentation/feedback module 114 and the visualization/reporting module 116. The data cleaning module 118 then uses a model of wind shear developed using past measured data, the identified good data, atmospheric data, and the sensor characteristics to deduce an expected value of the incorrect data. The data cleaning module 118 then replaces the identified defective data with the expected value produced using the models, data, and sensor characteristics. As illustrated by this representative example, the models and corrective methods employed by the data cleaning module(s) 118 can be quite complex. Another embodiment, using a simpler corrective module, may replace the defective data with an average of known good data. Thus, the models may be simpler as well.

Embodiments of the data defect detection and cleaning system 100 ensure that any and all corrections of the data are identified and can be rolled back. Thus, embodiments of the data defect detection and cleaning system 100 comprise versioning/audit module/system 130. As the name suggests, this module/system may be a versioning system so that multiple versions of the cleaned and uncleaned data are captured (or can be reproduced) and may also have auditing capabilities so that a complete reconstruction of all the actions taken can be identified and/or reconstructed.

Some embodiments of the versioning/audit module/system 130 are modules that are part of the data defect detection and cleaning system 100. Other embodiments are a separate system that performs the versioning and auditing functions on behalf of the data defect detection and cleaning system 100. In still other embodiments, one of the functions (e.g., versioning or auditing) are part of the data defect detection and cleaning system 100 while the other functions (e.g., auditing or versioning) are a separate system.

Some embodiments implement versioning of the data by capturing different versions of the data. Other embodiments implement versioning by capturing the changes that are made to the data so that any or all changes can be rolled back and different versions of the data can be produced. Still other embodiments implement versioning by combinations of these approaches, such as capturing different versions of the data in some circumstances while capturing changes in others or by capturing both the changes and the different versions, and so forth.

The purpose of auditing is to be able to identify exactly what actions were taken with respect to the data, who took the actions, when the actions were taken, why decisions were made, and so forth. Thus, auditing can capture not only what was performed, but other information such as the user feedback, the models used, decisions that were made, the time that changes were performed, the changes that were made, and/or combinations thereof. Having such an audit trail as well as the versioning allows review, validation, and verification of the data cleaning process and allows decisions to be rolled back if desired/needed.

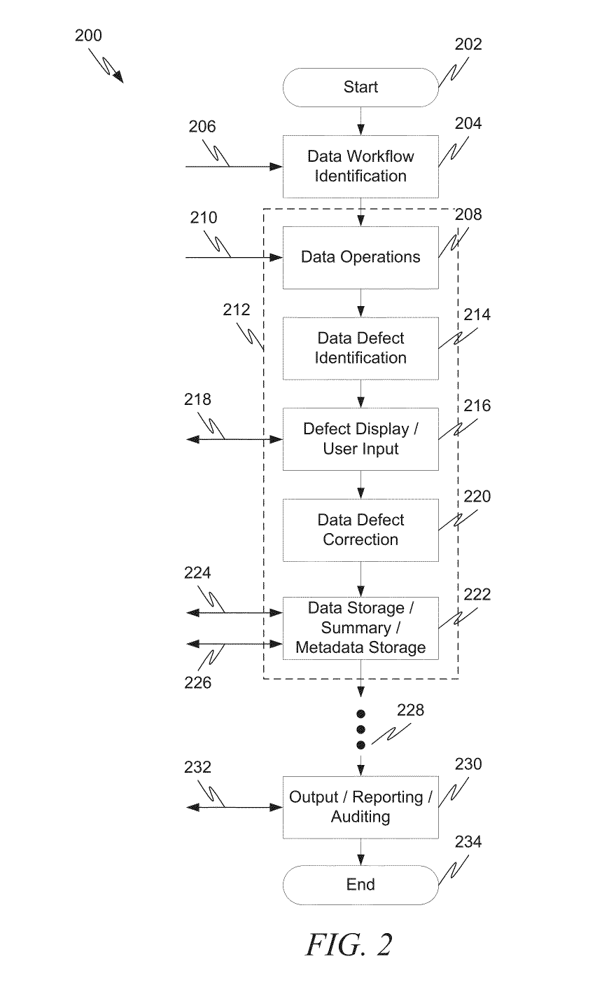

FIG. 2 illustrates an example of a flow diagram 200 to identify data defects and clean data. The example starts at 202, and operation 204 retrieves the desired workflow that outlines the workflow steps to be performed on the data during the defect detection and cleaning process as illustrated by arrow 206. As noted above, the references to workflow steps does not mean that the “steps” in the workflow are to be interpreted as step plus function. Rather, as discussed above, a workflow step includes one or more of the following:
Data reformatting, transformation, or reorganization in preparation for the succeeding operations.
Detection of specific types of defects based on particular methods, models, and so forth.
Presenting the detected defects to a user through visualization mechanisms such as numeric, textual, graphical, or other means.
Requesting and receiving input/feedback from the user to direct whether the identified defects are actually defects, how data is cleaned, and so forth.
Cleaning the data based on specific methods that can take the user feedback as input to the method. As an example, defects that are accepted (e.g., identified by the user as defects) are cleaned while defects that are rejected (e.g., identified by the user as not defects) are left alone.
Generation of various intermediate results such as:
   a. Defect summaries (e.g., number of defects by variable, by type, by time segment, and so forth);
   b. Multiple versions of the data (e.g., cleaned data after the particular operation, uncleaned data, and so forth);
   c. Information about user feedback (e.g., a log of which defects were rejected by the user, accepted by the user, and so forth);
   d. Log of user actions; and/or
   e. Information that allows any or all changes to be rolled back.
Storing of the intermediate results (on specified locations in some embodiments) for later review and assessment.

In the representative flow diagram of FIG. 2, various example operations are surrounded by dashed box 212. Any of the above identified operations can be included although not all embodiments need to have each and every operation above represented in each and every workflow step. In some embodiments, different workflow steps include different ones of the listed operations. Each of the various steps of a representative workflow comprise any combination of the above identified operations.

Once the workflow is retrieved, the system performs the operations comprising each workflow step. One such possible operation is indicated by operation 208, which performs any desired data operations prior to the remainder of the workflow step operations. Data operations include such operations as formatting, transformation, reorganization, scaling, normalization, or other manipulation of the data prior to the other operations in the workflow step. Since a representative system reads data from any source such as a single source (e.g., single flat file, single table from a database, and so forth), multiple single sources, and/or one or more complex sources (multiple tables from a single or multiple databases, disparate data sources like structured or unstructured text files, combinations thereof, and so forth), some operations within a workflow step may desire the data to be in a particular format or may desire data from multiple sources to be scaled, formatted, normalized, or otherwise manipulated. The data operations 208 represent these type of operations. Arrow 210 represents receiving the data from one or more sources and saving the manipulated data in a manner accessible by the other operations of the workflow step.

Operation 214 represents the data defect identification method(s) employed to identify potential defects in the data. This operation is performed in some embodiments by, for example, data defect module(s) 120 of FIG. 1. In some embodiments, operation 214 uses methods designed to detect particular types of defects in the data. As discussed above, such methods may rely on physical, statistical, or other characteristics, and/or models to identify defects. These characteristics/models can account for correlations among sensor data. One example noted above was that of a series of wind turbines producing electricity having sensors with a spatial relationship between them such as elevation and/or other distance measures. Measurements of wind speed, temperature, humidity, or other such parameters from spatially related sensors are often correlated in some fashion, particularly over small distances, elevation changes, and so forth. Some defect detection methods utilize such correlation to identify defects in such data.

Statistical models, physical models, physics models, correlation models, and so forth can help identify data that is “impossible” or has some other defect associated with it. In some embodiments, these models identify constraints to identify incorrect data. Taking the example of wind turbines that measure wind speed at various elevations, consider the wind speed data measured by two sensors located a fixed distance apart. When the difference between the wind speeds measured by the two sensors exceeds what is likely and/or possible, then a potential defect in the data is identified. A third sensor located in proximity to the others can help sort out which of the measured speeds contains the potential defect. Similarly, prior measured data may indicate when data is incorrect. As yet another example, a sensor may be calibrated to measure a minimum or maximum value and when the data from that sensor exceeds the minimum or maximum value, errors may be detected. Other models may correlate data from different types of sensors such as temperature, pressure, speed, and so forth. Thus, when one parameter changes, an appropriate model predicts that one or more other parameters are expected to change in a defined way. Sometimes physics describes relationships between different types of sensors, such as the temperature and pressure of a gas in a closed container. Sometimes models may be based on empirical information gathered over time or through experimentation.

As discussed previously, statistical models, physical models, physics models, correlation models, and so forth can help identify constraints which help identify potential defects. The models may be quite complex and often go beyond simple if-then type relationships. The models may be of characteristics of the data (such as statistics of the data), of the sensor (such as sensor response to input, noise models, and so forth), the sensor context (such as the industrial process, environment, and so forth within which the sensor resides), and so forth. As discussed above, the models may account for or utilize sensor metadata, referred to as proximity information or proximity data. Thus, measured data may include (or be related to) proximity information which details any combination of information about the sensor, the environment of the sensor, its relationship to other sensors, and so forth to produce sensor metadata that is utilized in these models to identify constraints or other information used to detect potential defects. As discussed above, examples of proximity data include, but are not limited to, any combination of the following.
Type: The type of physical variable measured by the sensor such as temperature, pressure, speed, concentration, and so forth.
Subtype: Within a given type, there can be subtypes of variables that describe characteristics of the type. As an example, the variable measured may be temperature, and the subtype may be oil inlet temperature, water coolant temperature, ambient temperature, and so forth.
Location: This includes the physical or relative location such as which machine, which part of a machine, the portion of the process, a geographic location, and so forth.
Spatial Arrangement: This describes the relationship between a sensor and related or neighboring sensors. It helps identify correlations between measured data and aids in detection of incorrect data. For example, a data defect may be detected if a big jump in temperature occurs for the oil inlet temperature sensor over a short period of time. However, the big jump may only be an error if a similar jump does not show up on sensors that are “close” or “correlated” to the oil inlet temperature sensor such as one or more oil temperature sensors located upstream and/or downstream from the oil inlet temperature.
Other sensor or environment metadata.

Once potential defects have been identified in operation 214, operation 216 displays the potential defects and allows a user to provide feedback on the potential defects and/or other input. Arrow 218 indicates the display/input/feedback. In some embodiments, visualizations are used to present defects to the user. Although some example visualizations are presented below, visualizations can include any combination of visual, textual, graphical, and other information to help highlight potential defects and allow a user to provide feedback. As an example, feedback includes any combination of: 1) which potential defects are “accepted” and should be corrected; 2) which potential defects are “rejected” and should be left alone; 3) which potential defects should be evaluated further; and so forth. Feedback can also include other items like information that will be used to correct the identified defects (e.g., method used to correct defects, parameters used by a method to correct defects, and so forth), comments or other information that identifies why a decision was made, information calling for further analysis and/or review, and so forth.

Information presented in operation 216 is often interactive in that it allows a user to jump to potential defects and navigate the potential defects for evaluation and feedback. Some examples are presented below.

Operation 220 illustrates the correction of identified defects taking into account the feedback and/or input provided by the user. This process is sometimes referred to as data cleaning. However, the methods used to correct identified defects are often much more complex than models used to correct data defects in other contexts. For example, the methods used to correct the identified defects are based on the type of defect being addressed and may also be based on the statistical models, physical models, physics models, correlation models and so forth previously mentioned. Thus, the data defect correction operation 220 often uses proximity information and/or sensor/process information.

As one example, suppose the data defect detection operation 214 and identified a possible error in the radial gas pressure associated with a turbine. The suspected defect was confirmed by the user by in operation 216. The data defect correction operation 220 then uses a model of radial gas pressure developed using a physical model of the turbine along with physics model of the expanding hot gas, past measured turbulence data, measured correlated data from other sensors, and the sensor characteristics to identify an expected value of the incorrect data. The data defect correction operation then replaces the identified defective data with the expected value produced using the models, data and sensor characteristics.

Operation 222 represents both generation of various intermediate results and storage of intermediate results, if desired. As discussed above, intermediate results include any combination of such items as: defect summaries (e.g., number of defects by variable, by type, by time segment, and so forth), multiple versions of the data (e.g., cleaned data after the particular operation, uncleaned data, and so forth), information about user feedback (e.g., a log of which defects were rejected by the user, accepted by the user, and so forth), and a log of user actions and/or information that allows any or all changes to be rolled back. Storing of the intermediate results includes, without limitation, storage at/on specified locations in some embodiments for later review and assessment. Storage of intermediate results is depicted by arrows 224 and 226.

The ellipses 228 indicate that multiple workflow steps may be part of the workflow. In addition, a single workflow step may be performed multiple times.

Operation 230 represents the output of the method including reporting and auditing. Arrow 232 represents output of the desired information. The method then ends as indicated by bubble 234.

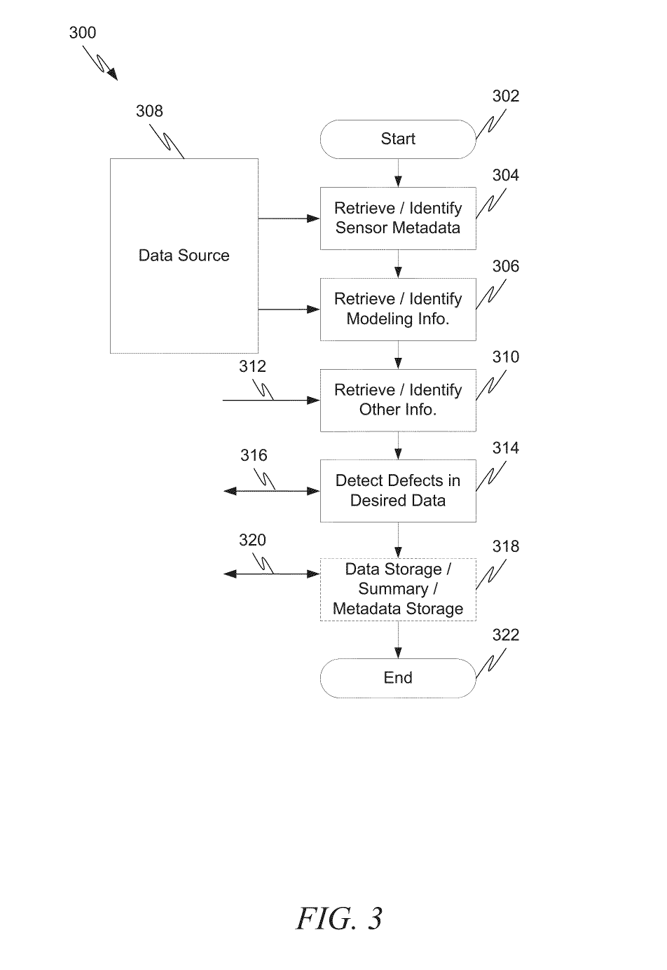

FIG. 3 illustrates an example of a flow diagram 300 to detect defects. As such, the diagram represents an example embodiment of operation 214 of FIG. 2. The process starts at operation 302 and retrieves or identifies the sensor data in operation 304. In some embodiments, the information obtains information from a data source 308. Data source 308 represents any of the various options that are used in different embodiments as a data source. As one example, data source 308 represents a system such as data source 102 of FIG. 1. In another example, data source 308 represents data from a single source such as a single flat file, single table from a database, multiple tables from a single database, and so forth. In yet another example, data source 308 represents a complex source such as multiple tables from multiple data bases, disparate data sources such as structured and unstructured text files, various data tables, and so forth. Operation 304 either retrieves the data from the data source 308 or identifies from where it can be retrieved.

Operation 306 retrieves and/or identifies modeling information associated with the data. As explained above, data defect identification utilizes models such as statistical models, physical models, physics models, correlation models, and so forth to help identify data that is “impossible” or has some other defect associated with it. In some embodiments, the models that are used are derived from past data or known good data. In some embodiments, the models are developed using physics and/or an understanding of the processes and/or characteristics of the system that produced the data. Examples that have been previously presented include using models of wind turbines, temperature for processes, correlation among sensors and/or sensor types (e.g., temperature, pressure and so forth), and so forth and these need not be repeated here.

In general, statistical models, physical models, physics models, correlation models, and so forth can help identify constraints which help identify defects. These model(s) that model sensors, environment, statistics, physical attributes, physics, correlation, and so forth may be quite complex and often go beyond simple if-then type relationships.

As previously explained, the models may account for or utilize particular sensor metadata, also referred to as proximity information or proximity data. Thus, measured data may include (or be related to) proximity information which details information about the sensor, the environment of the sensor, its relationship to other sensors, combinations thereof, and so forth to produce sensor metadata that is utilized in these models to identify constraints or other information used to detect defects. Examples of proximity data have been described above.

Operation 310 and arrow 312 represent retrieval and/or identification of any other information that is utilized by the data defect detection method. Such other information can include, but is not limited to, prior sets of data, information that allows proper formatting, scaling and so forth of the data, and any other information that is used for the defect detection.

Operation 314 and arrow 316 represent the process of data defect detection. Data defect detection uses the model(s), data, and other information previously described to identify particular defects in the data. The model(s) and other information are typically focused on detecting particular types of data defects. As such, the models and other information typically define constraints that show data that is suspected of having one or more defects.

One example previously illustrated include sensors that measure data that is outside of expected, modeled, statistical, or other bounds when compared to data from other sensors, expected values, or other statistical measures. Thus, the wind speed example above or a sensor measuring a parameter that is correlated in some fashion to other sensor data (either contemporaneous or non-contemporaneous) illustrate a type of data defect that can be detected using the models previously discussed.

As another example, segmenting the data over different types of sensor data can reveal defects. For example, some sensor measurements and other values (e.g., wind speed, turbulence intensity, and so forth) might be tagged as having data quality issues if the data is segmented by wind direction and then combined. The method combines the information across various segments to identify the data quality problems.

Missing data is another category of examples that can be detected. In this set of examples, not finding data where it is expected (e.g., at a particular time or with a particular time stamp) can be detected, for example, by comparing the time stamps between data samples.

In yet another set of examples, the system may detect and/or correct for clock skew or clock misalignment between data sets. Thus, data from different sensors may have differences between their clocks (e.g., the clocks available to different sensors may not be in sync). Statistical and/or heuristic and/or other reasoning is employed in different embodiments to shift around the time stamps (e.g., to correct clock skew/offset) to bring the data from different sensors in sync. Sometimes such analysis will indicate that all time stamps should be shifted by a constant amount. Sometimes such analysis will indicate that shifting should be performed differently in different time periods. In this latter case, the system may intelligently detect the particular time periods where shifting should be done, but leave the rest of the timestamps unchanged. In some embodiments, the amount of shifting is presented to a user as a suggestion/suspected defect (e.g., treated as a type of data defect) as discussed below so that the user can accept, reject, and/or modify the suggestion.

When detecting differences between clocks from different sensors, it may be difficult to determine which sensor or sensors are at fault and, hence, need to be corrected. As discussed, statistical, heuristic, and/or other reasoning is employed by different embodiments to detect which sensors to correct. In some embodiments, any combination of Bayesian methods, Bayesian Belief Networks, Optimization, Heuristics-based methods, and so forth are used to detect the potential defects.

Once the potential defects are detected, operation 318 represents capturing metadata, intermediate results, potential defects, and/or other information both as a log of what happened (for audit and/or reversal purposes) and in order to allow the next phase of the workflow step to be accomplished. Arrow 320 represents input and/or output as part of this capture.

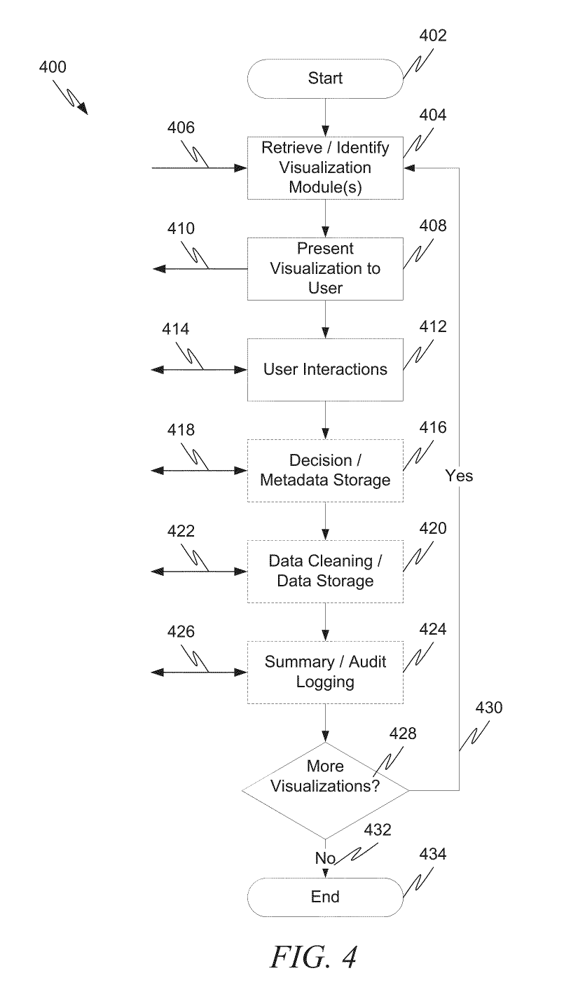

FIG. 4 illustrates an example of a flow diagram 400 for visualization of the data and for user feedback on detected defects. Thus, FIG. 4 represents an example of a method implemented by the data cleaning module(s) 120, the visualization module(s) 116, and/or user presentation/feedback module 114.

The method starts with operation 402 and in operation 404 retrieves and/or otherwise identifies the visualization module(s) that will be used to present visualization(s) of suspected defects to the user as indicated by arrow 406. Example visualizations are discussed below. Visualizations comprise any combination of text, graphics, user interface elements, data files, and so forth in order to convey the potential defects to the user in a manner so that they can be understood and so that feedback can be received from the user on what to do with the suspected defects.

Operation 408 along with arrow 410 represent presentation of the visualization to the user, and operation 412 and arrow 414 represent user interactions to provide feedback on the suspected defects and/or further direction on how to handle the suspected defects.

As the user interacts with the visualization, embodiments of the system gather information that the system uses to handle suspected defects. Such information includes, but is not limited to, any combination of decision information, data cleaning information, summary information, metadata information, audit information, logging information, and so forth. Some of these categories may overlap, but the result of the data gathering is that the system has information about how to handle the data defects and how to document and/or reverse decisions made by the user for audit and logging purposes. Operation 416 and arrow 418 represent capturing the decision, feedback, input, metadata changes, and so forth in order to handle the suspected data defects.

Operation 420 and arrow 422 represent the actual cleaning of the data according to the feedback/input/instructions from the user. Operation 420 is shown as optional since such an operation may be performed in real time (e.g., in an interactive manner) in some embodiments. In other embodiments, the actual data cleaning is performed outside of the interactive loop (e.g., as a batch or separate process). In still other embodiments, combinations thereof are used with some defects being corrected in an interactive manner and others as a separate or batch process. If the system performs the cleaning operation in a later process or in a non-interactive manner, it can utilize the data captured by operation 416 to perform the cleaning operation.

Operation 424 and arrow 426 represent capturing information to allow logging/audit. The information captured not only allows logging/auditing, but also reversal of some or all of the decisions made. This may entail, for example, the system utilizing any combination of capturing different versions of the data, capturing instructions that can be used to generate any version of the data, capturing instructions (e.g., change instructions) executed on the data, and so forth.

Decision block 428 and “yes” branch 430 represent determining that there are more visualization(s) to be presented to the user. If, however, there are no more visualizations to be presented to the user, then the “no” branch 432 is taken and the method ends at 434.

The recursive loop for multiple visualizations indicates that for a given set of suspected defects, there may be more than one useful visualization to be presented to a user. As discussed above, a single workflow step includes, among other things:
Detection of specific types of defects based on particular methods, models, and so forth.
Presenting the detected defects to a user through visualization mechanisms such as numeric, textual, graphical, or other means.
Requesting and receiving input/feedback from the user to direct whether the identified defects are actually defects, how data is cleaned, and so forth.
Cleaning the data based on specific methods that can take the user feedback as input to the method. As an example, defects that are accepted (e.g., identified by the user as defects) are cleaned while defects that are rejected (e.g., identified by the user as not defects) are left alone.

As outlined above, various combinations of data defect detection and visualization/feedback presenting and data cleaning exist in different workflow steps. Thus, there may be multiple visualizations and/or feedback in a single workflow step. Similarly, a single workflow step may direct detection of multiple types of defects, using similar or different methods, models, and so forth. These multiple types of defects may utilize multiple visualizations (either combined or individually). Similarly, there is not necessarily a 1:1 correspondence between visualizations presented, feedback received, and cleaning methodologies employed.

FIGS. 5-7 illustrate example data visualizations and discuss different ways in which a user might interact with the visualizations in representative examples.

FIG. 5 illustrates an example data visualization 500 showing missing data. In this visualization, the data is for a particular data set (e.g., data from a data source). For example, the data may be for one or more steam turbines or for a manufacturing plant (or part of the manufacturing process) and so forth. The columns 502 represent appropriate column variables while the rows represent appropriate row variables 504. As a representative example, if the visualization is for a power plant with steam turbines, the columns 502 can represent different steam turbines while the rows 504 can represent a time variable, such as months of the year.

The shading/coloring of the individual cells represents the percentage of data missing. For example, in the key illustrated in FIG. 5, a white box 506 represents no data (e.g., 100% missing data), a slightly darker box 508 represents 0%-50% data (e.g., 100% to 50% missing), a darker box 510 represents 50%-90% data (e.g., 50% to 10% missing), a darker box 512 represents 90%-100% data (e.g., 10% to 0% missing), and a solid dark box 514 represents 100% data (e.g., no missing data). By presenting the data in this way, the user can identify patterns of when data is missing.

The user can gain more detailed information by selecting a particular cell (such as by clicking, tapping, touching, or otherwise). Upon selecting, detailed information is displayed. In some embodiments, the information is displayed in a pop-up box. Thus, a user clicking on the cell 516 will be presented with pop-up box 518 where the detailed information, such as a listing of date, speed, temperature, missing information, and so forth, are displayed. In other embodiments, the information is displayed in a detailed data display region, such as 522. Data displayed either in a pop-up box 518 or in a display region 522 can contain controls to allow scrolling of the information in the window in order to view data that would not otherwise fit. Thus, data display region 522 has a scroll bar 524 and thumb (e.g., scrolling control) 526. The thumb 526 can illustrate the portion of the data displayed by its size (e.g., a larger size means a larger percentage of the data is displayed). Thus, in these embodiments, when a user selects a cell, such as cell 520, the data is displayed in display region 522, with scroll controls as appropriate. Some embodiments use a combination of pop-up boxes and display regions to display information about a selected cell.

Some embodiments allow smart zooming of the displayed information. Thus, while initially displaying either row and/or column variables at a particular scale, zooming will change the scale of the row and/or column. As a representative example, if the rows display months of the year and the columns display steam turbines, zooming in the “row” dimension may change the scale from months to weeks, to days, to hours, and so forth depending on how far a user zooms in. Zooming out would have the opposite effect (e.g., changing from weeks to months to years and so forth). Zooming in the “column” dimension may change the scale from a particular machine (e.g., a particular steam turbine) to different categories of the sensors on the machine (e.g., temperature, pressure, and so forth) to individual sensors within a category and so forth. Alternatively, or additionally, zooming in may change the scale from a particular machine to a particular portion of the machine (e.g., inlet system, outlet system, turbine system, and so forth), to sensors in those portions, and so forth. A zoom hierarchy can be defined for each dimension and multiple zoom hierarchies can exist for a given dimension. When multiple zoom hierarchies exist, a user can select the hierarchy to use for zooming.

Rather than a table with row and column variables, a diagrammatic representation of the domain can be used with colors applied to regions of the diagrammatic representation. Thus, if the domain is a refinery process, a process flow diagram or other diagrammatic representation of the refinery can be displayed with appropriate shading and/or color coding to represent different levels of missing data over a particular time scale. Again, the user can zoom either along the time dimension or the diagrammatic dimension of such a representation.

In some embodiments that use a table with row and column dimensions for visualization, a user can select from a list of variables and drag/drop them on the appropriate dimension. Zooming along a “z” dimension can be represented by displaying a series of tables, each representing a “slice” through a three (or more)-dimensional cube. As an example, a table can represent temperature vs. pressure for a given period (say a month). Preceding and succeeding months can be displayed by scrolling in or out of the display.

The color scale (e.g., shading and/or color representing the percentage of data available and/or missing) is changed on the fly in some embodiments. Thus, as the scale changes, the color scale is updated to reflect the zoom. Additionally, or alternatively, the user can update the scale to different ranges as desired and have the visualization dynamically updated.

When the visualization is utilized to collect feedback on how to correct potential defects, the visualization can also contain options that the user can select and/or otherwise invoke to direct which and how the data should be cleaned. For example, the user may determine to leave a particular cell alone since the missing data was due to a turbine being taken offline for maintenance. Thus, the missing data is a correct representation of the state of the turbine and not an error. In another cell, the user may direct that the missing data be replaced by some function of the remaining data (e.g., a missing temperature be derived by averaging the two closest data points or a missing temperature be derived using a model that takes surrounding pressure and volume into account or a combination of both).

Finally, the visualizations presented in any of the figures herein are implemented as widgets in some embodiments so that the visualizations can be utilized not only in an interactive way for potential defect detection/correction, but also in other contexts such as reporting, interactive data evaluation, and so forth.

FIG. 6 illustrates an example data visualization 600 identifying potential data defects. In this visualization, time series data 602 is presented to the user. The time series data 602 may comprise multiple time series data shown by curves 610, 612 and 614. In one representative example, the time series data 602 shows data from related and/or correlated sensors. As a more specific example, curves 610, 612, and 614 may represent individual time series data from sensors located at an elevation where a potential defect was detected or individual time series data from sensors located in proximity in an industrial process, storage tank, or other location.

The potential defect that was detected is highlighted, offset, or otherwise emphasized to draw the user's attention to the potential defect. In FIG. 6, a representative potential defect is bounded between dashed lines 626 and 624. The lines not only highlight the time segment of interest, but they also allow easy comparison to reference series (discussed below), such as 604 (with curves 616, 618 and 620) and/or 606 (curves not numbered). The defect may also be bounded in box 622, which can be colored, shaded, highlighted, and so forth in such a way as to draw the user's attention.

Some embodiments of the visualization also present reference or comparison series to illustrate why the data is suspected of having a potential defect. Such data can be actual (drawn, for example, from nearby or otherwise related sensors), or can be calculated, estimated, detected by a model, and/or so forth. Using the example of a wind farm from above, the reference series can be a series showing wind speeds from other nearby heights or nearby wind turbines. Similarly, if the series was the temperature of a containment vessel, the comparison series could be drawn from temperature sensors located at other nearby locations in the containment vessel or series from sensors measuring parameters that would be expected to influence the temperature of the contents of the containment vessel (e.g., through a model or other calculation).

If the data is not a specific reference signal but is derived from a model or other calculation to produce expected values, the series can be presented as shown in FIG. 6, or other mechanisms can be used to illustrate the potential defect. For example, if the model produces constraints of some sort (e.g., a maximum wind speed or wind speed gradient), then the calculated limits, bounds, or other constraints can be illustrated on the time series, such as by showing an expected band, limit, or other representation. As one representative example, in the case of a maximum wind speed, the series 602 may show a line or limit beyond which data would not be expected to go. As another representative example, in the case of a maximum wind speed gradient, data from other sensors can be used to calculate a time-varying limit beyond which data would not be expected to go. However, these are only representative examples, and other mechanisms can be used to highlight possible defects.

Supporting or detailed data can also be presented as illustrated in FIG. 6. FIG. 6 illustrates supporting data as table 608, which contains information that allows a better comparison or provides the basis for a user to make a determination for the potential defect. As an example, if the domain was a wind farm where the data series was gathered from wind speed sensors, the supporting data could contain data points showing sensor ID, the variable measured, the height, the start date and end date (e.g., the limits shown by dashed line 624 and 626), the minimum value over the time frame, the maximum value over the time frame, the range covered by the data, the percentage of missing data over the time frame, and so forth. Thus, in this representative example, supporting data table 608 contains a summary of data and/or statistics on wind speed and/or other factors influencing wind speed over the defective segment.

Some embodiments of the visualization of FIG. 6 allow the user to drag reference series, add/remove other information such as expected values, statistical measures, or other modeled or calculated characteristics, and so forth to explore the different aspects of the potential defect. Some embodiments also allow the user to click a “next” button or other control that will jump the user to the next suspected defect in the data. In this way, navigation becomes easy so that the user can focus on suspected defects and not waste time scrolling through data that has no suspected defects. Embodiments of the visualization also allow the user to provide feedback such as any combination of marking a suspected defect as an actual defect (and hence to be cleaned), marking a suspected defect as ok (so that it will not be cleaned), indicating further analysis that should be performed on the suspected defect, indicating how the defect should be cleaned, and so forth.

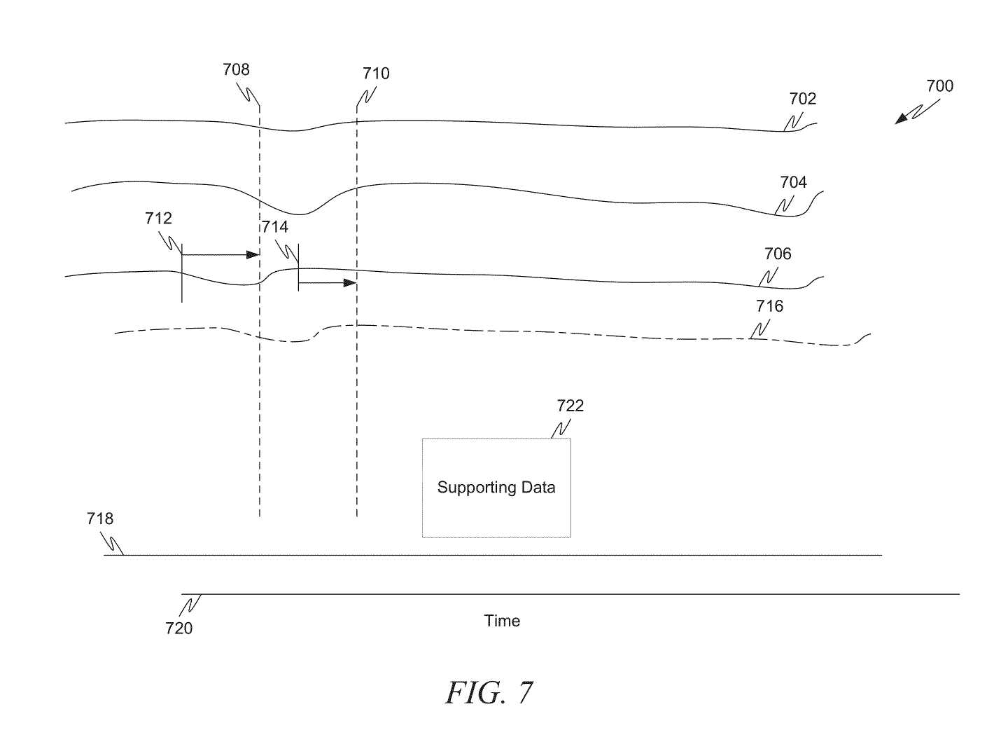

FIG. 7 represents an example data visualization 700 for clock correction. In the example visualization, multiple time series data are depicted such as time series 702, time series 704, and time series 706. In the example, the system has detected a suspected clock skew issue with time series 706 over the time frame bounded by dashed line 708 and 710 in the reference (e.g., not skewed) series. The system highlights the suspected skewed data on time series 706 by lines 712 and 714. Any mechanism can be used to highlighted the suspected time period such as a bounding box, changing the color of the suspected time period on the skewed data (e.g., time series 706) and/or non-skewed data (e.g., time series 702 and/or 704), and so forth.

A time line 718 and/or supporting data 722 are also displayed in some embodiments. Supporting data comprises any combination of information that illustrates the suspected defect and/or helps the user to make a determination regarding the suspected defect. For example, the supporting data can contain correlation factors for the raw (e.g., non-corrected data) as well as suggested corrections, correlation factors if the corrections are accepted, options available, and so forth.

Using controls provided, the user can direct the system to show what the data will look like if the corrections are applied and/or allow the user to apply/reverse the suggested corrections to “blink” between the two states in order to compare one against the other. In addition, multiple views of the uncorrected data displayed alongside the corrected data are used in some embodiments. Thus, data series 716 can be displayed to illustrate what the corrected series 706 would look like if the suggested corrections are accepted. Additionally or alternatively, the information about the corrected/uncorrected data can be displayed in the supporting data 722 or in multiple sets of supporting data (e.g., one using uncorrected data, one using the corrected data).

Finally, a secondary and/or corrected timeline 720 is displayed in some embodiments to highlight the corrections made (or that will be made) to the data if the suggestions are accepted.

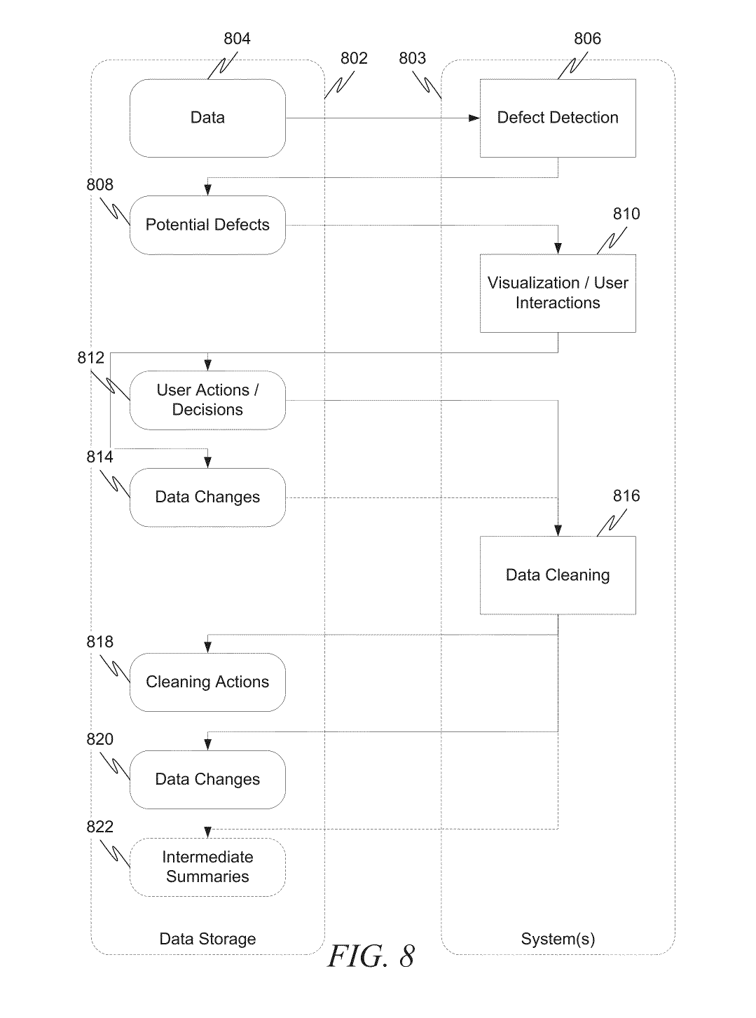

FIG. 8 represents an example flow diagram for data defect detection and cleaning. This flow diagram shows a representative data flow between data storage 802 and the system(s) 803 performing the data defect detection and cleaning. In describing the various operations that are performed, the term “modules” will be used. Modules are described in more detail below. In some embodiments, the modules are implemented as systems themselves, thus a data detection system, a visualization system, a data cleaning system and so forth.

Data 804 is retrieved by a defect detection module and potential defects are detected as described in the example embodiments above (e.g., FIG. 1, FIG. 2, FIG. 3 and so forth). Once potential defects have been identified, information describing the potential defects 808, along with any intermediate results (not shown) that should be captured, are saved.

The potential defects are utilized by visualization/user interaction module 810 to present potential defects to the user and to get feedback, input, and/or other direction on how and whether cleaning should occur. The user actions/decisions/feedback, and so forth are stored as shown in 812. In addition, any data changes made interactively by the user can be saved 814 along with any intermediate summaries (not shown).

The data cleaning module 816 utilizes the user feedback and other user input along with any data changes to clean the data in accordance with the feedback. At this point, the cleaning actions 818, data changes 820, and optional intermediate summaries 822 are captured. Alternatively, or additionally, multiple versions of the data can captured as described elsewhere. The stored information allows auditing, logging, rollback, reporting, and/or so forth as previously described.

As indicated above, the sequence of operations in 803 can be performed once, multiple times, or however else directed by the workflow and workflow steps. Each step may generate data, plots, tables, and so forth for future reporting purposes. Thus, the information illustrated in FIG. 8 are stored in specific data structures in memory and/or structured and/or unstructured files on disk storage, or otherwise appropriately preserved. Collectively this information is referred to herein as Report Metadata.

The systems and representative embodiments described herein comprise reporting capability as previously discussed. In some embodiments, the reporting modules are designed to generate different reports of pre-specified structure. These modules access Report Metadata to generate the actual reports. Reports include, but are not limited to, any of the following alone or in combination: ASCII (e.g., text) files, standard document types (e.g., PDF, RTF, DOCX, etc.), static or interactive web pages, XML files, and so forth.

The final output of embodiments described herein include various information and/or data. The outputs include, but are not limited to any of the following alone or in combination.
One or more versions of cleaned data in specified formats. Different versions are designed for consumption by different downstream applications.
The action of uploading cleaned data to specified databases, remote machines, shared folders, and so on.
Various metadata on defects in the data such as location (e.g., row and column positions, time offset, location within a file, and so forth), confidence scores signifying how sure the system is about the cleaned values in a field, row, cell, and so forth.

Note that different embodiments may be implemented in different ways so that data cleaning modules, workflow steps, and so forth may not be executed on the same physical and/or virtual system, but may be spread across machines in a distributed manner. Similarly, various aspects are implemented in the cloud and/or as a service in some embodiments.

### Modules, Components and Logic

The embodiments above are described in terms of modules. Modules may constitute either software modules (e.g., code embodied (1) on machine-readable medium or (2) in a transmission medium as those terms are described below) or hardware-implemented modules. A hardware-implemented module is tangible unit capable of performing certain operations and may be configured or arranged in a certain manner. Hardware modules are configured either with hardwired functionality such as in a hardware module without software or microcode or with software in any of its forms (resulting in a programmed hardware module) or with a combination of hardwired functionality and software. In example embodiments, one or more computer systems (e.g., a standalone, client or server computer system, computing devices and so forth) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations to result in a special purpose or uniquely configured hardware-implemented module. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a processor configured using software, the processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein are at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures may be employed. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

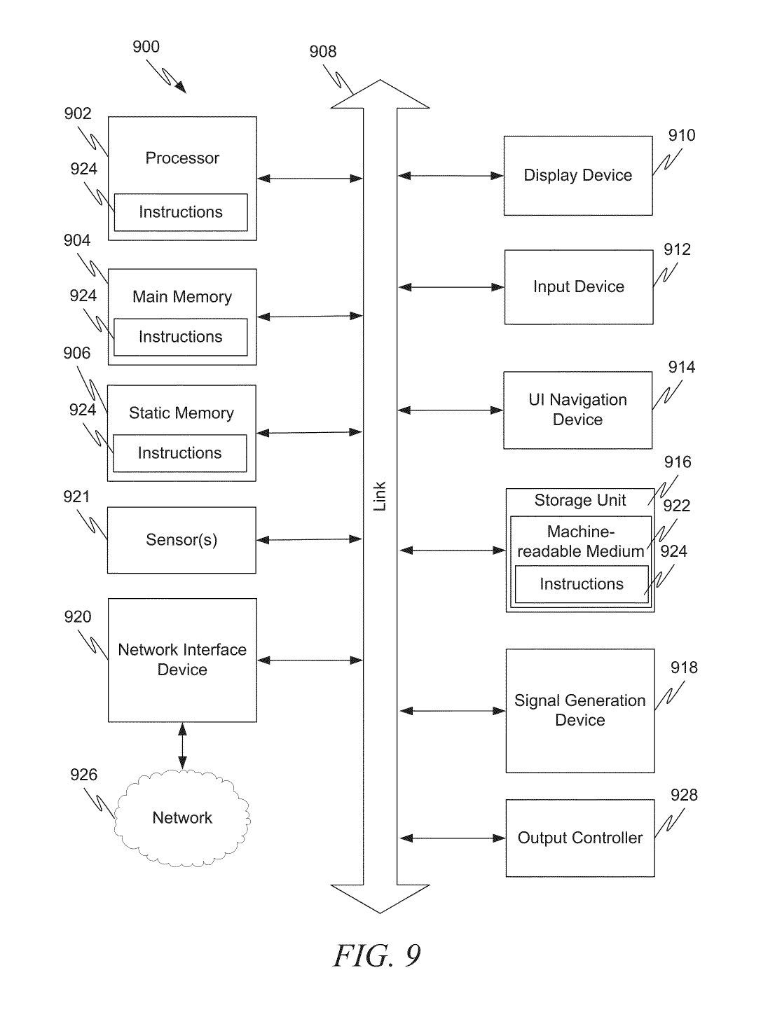

FIG. 9 is a block diagram of a machine in the example form of a processing system within which may be executed a set of instructions for causing the machine to perform any one or more of the methodologies discussed herein including the functions, systems and flow diagrams of FIGS. 1-8. Said another way, the representative machine of FIG. 9 implements the modules, methods, and so forth described above in conjunction with the various embodiments.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment to implement the embodiments described above either in conjunction with other network systems or distributed across the networked systems. The machine may be a personal computer (PC), a tablet PC, a set-top box (STB), a personal digital assistant (PDA), a cellular telephone, a smart phone, a tablet, a wearable device (e.g., a smart watch or smart glasses), a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the machine 900 includes at least one processor 902 (e.g., a central processing unit (CPU), graphics processing unit (GPU), advanced processing unit (APU), or combinations thereof), a main memory 904, and static memory 906, which communicate with each other via link 908 (e.g., bus or other communication structure). The machine 900 may further include display unit 910 (e.g., a plasma display, a liquid crystal display (LCD), a cathode ray tube (CRT), and so forth). The machine 900 also includes an alphanumeric input device 912 (e.g., a keyboard, touch screen, and so forth), a UI navigation device 914 (e.g., a mouse, trackball, touch device, and so forth), a storage unit 916, a signal generation device 918 (e.g., a speaker), sensor(s) 921 (e.g., global positioning sensor, accelerometer(s), microphone(s), camera(s), and so forth), a network interface device 920 and an output controller 928.

### Machine-Readable Medium

The storage unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904, the static memory 906, and/or within the processor 902 during execution thereof by the machine 900, with the main memory 904, the static memory 906, and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks. The term machine-readable medium specifically excludes non-statutory signals per se.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Transmission medium encompasses mechanisms by which the instructions 924 are transmitted, such as communication networks. Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Unless specifically stated otherwise, discussions herein using words such as “processing,” “computing,” “calculating,” “determining,” “presenting,” “displaying,” or the like may refer to actions or processes of a machine 900 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A device comprising at least one hardware implemented module configured to at least:
retrieve time series data measured from at least one sensor;
retrieve proximity data about the at least one sensor, the proximity data comprising:
sensor ID metadata for the at least one sensor; or
sensor environment metadata for the at least one sensor; or
both the sensor ID metadata for the at least one sensor and the sensor environment metadata for the at least one sensor;
detect a first set of defects in the retrieved time series data using constraints based upon at least one of:
at least one stored model of the at least one sensor, a location for the at least one sensor, or both; or
a statistical model; or
other constraints that relate to the time series data or proximity data;
present, via a user interface (UI), information relating to the first set of defects defects and receive, via the UI, feedback about the first set of defects;
clean the time series data based on the feedback;
capture information to allow reversal of changes in whole or in part made to the time series data based on the feedback.

2. The device of claim 1 wherein the information related to the first set of defects presented via the UI is selected by the device automatically based on the proximity data or other relevant domain information.

3. The device of claim 1, wherein the hardware implemented module is further configured to retrieve a work flow describing a series of cleaning operations to be applied to the time series data, the cleaning operations comprising:
at least one defect detection module to detect a set of defects in the time series data;
at least one visualization module to present information relating to detected defects and to receive feedback regarding the defects;
at least one data cleaning module to clean the time series data based on the received feedback; and
a versioning module to capture multiple versions of the time series data.

4. The device of claim 3, wherein the hardware implemented module is further configured to allow a user to modify the workflow by adding or deleting cleaning operations.

5. The device of claim 3, wherein the versioning module captures information allowing the multiple versions of the time series data to be created.

6. The device of claim 3, wherein the versioning module allows any changes to the time series data to be reversed in whole or in part.

7. The device of claim 3, wherein:
the at least one defect detection module detects the first set of defects;
the at least one visualization module presents, via a UI information relating to the detected defects and receive, via the UI, feedback about the first set of defects;
the at least one data cleaning module cleans the time series data based on the feedback; and
the versioning module captures information to allow reversal of changes in whole or in part made to the time series data based on the feedback.

8. A method performed by a device to clean time series data, the method comprising:
retrieving time series data measured from at least one sensor;
retrieving proximity data about the at least one sensor, the proximity data comprising sensor ID metadata or sensor environment metadata or both; and
performing at least one cleaning operation, each cleaning operation comprising:
detecting a set of defects in the retrieved time series data using at least one constraint based on any combination of:
the proximity data;
a statistical model;
a model relating to the proximity data; or
a characteristic of the time series data or proximity data;
presenting, via a user interface (UI), information relating to the detected defects and receiving via the UI, feedback about the first set of defects;
cleaning the time series data based on the feedback; and
capturing information to allow reversal of changes in whole or in part made to the time series data.

9. The method of claim 8, further comprising performing multiple cleaning operations that result in multiple versions of the time series data.

10. The method of claim 8, wherein each cleaning operation further comprises capturing information for reporting.

11. The method of claim 10, wherein reporting comprises intermediate summaries that establish a clear audit trail of the data cleaning process.

12. The method of claim 10, wherein information captured for reporting and information captured to allow reversal of changes is the same set of information.

13. A computer storage medium comprising computer executable instructions that when executed configure a device to at least:
retrieve time series data measured from at least one sensor;
retrieve proximity data about the at least one sensor, the proximity data comprising sensor ID metadata or sensor environment metadata or both; and
perform at least one cleaning operation, each cleaning operation configuring the device to at least:
detect a set of defects in the retrieved time series data using at least one constraint based on any combination of:
the proximity data;
a statistical model;
a model relating to the proximity data; or
a characteristic of the time series data or proximity data;
present, via a user interface (UI), information relating to the detected defects and receive, via the UI, feedback about the first set of defects;
clean the time series data based on the feedback; and
capture information to allow reversal of changes in whole or in part made to the time series data.

14. The computer storage medium of claim 13, further comprising instructions to configure the device to retrieve a workflow describing the at least one cleaning operation.

15. The computer storage medium of claim 13, further comprising instructions to configure the device to perform multiple cleaning operations that result in multiple versions of the time series data.

16. The computer storage medium of claim 13, wherein each cleaning operation further configures the device to capture information for reporting.

17. The computer storage medium of claim 16, wherein reporting comprises intermediate summaries that establish a clear audit trail of the data cleaning process.

18. The computer storage medium of claim 13, wherein information captured for reporting and information captured to allow reversal of changes is the same set of information.

19. The computer storage medium of claim 13, wherein the at least one constraint is based on a model of physical characteristics of the sensor and the environment of the sensor.

20. The computer storage medium of claim 13, wherein the at least one constraint is based on prior data.
